(19) United States
(12) Patent Application Publication
(10) Pub. No.: US 2007/0119025 A1
(43) Pub. Date: May 31, 2007

(54) HINGE ASSEMBLY FOR FLAT DISPLAY MONITOR

(75) Inventor: An-Kui Hu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,517

(22) Filed: Aug. 16, 2006

(30) Foreign Application Priority Data
Nov. 25, 2005 (TW) 094141544

(51) Int. Cl. E05D 11/08

(52) U.S. Cl. 16/340

(57) ABSTRACT

A hinge assembly (300) includes a support seat (10), a base seat (20) and a pivot mechanism (30). The support seat defines a pivoting hole (160). The base seat defines an engaging hole (242). The pivot mechanism rotatably connects the support seat to the base seat. The pivot mechanism includes an irregular-holed tab washer (41) defining an irregular hole (414) and a pivotal shaft (31). The pivotal shaft non-rotatably engages in the engaging hole of the base seat and rotatably engages in the pivoting hole of the support seat. The irregular-holed tab washer surrounds the pivotal shaft and is non-rotatably mounted to the support seat. The pivotal shaft engages with the irregular hole of the irregular-holed tab washer for limiting a rotation angle between the support seat and the base seat.

### 1. FIELD OF THE INVENTION

The present invention generally relates to a hinge assembly and, particularly, to a hinge assembly for a flat display monitor.

### 2. DISCUSSION OF THE RELATED ART

With the widespread use and the variety of computers available, display devices configured for such a variety of computers also come in a variety of sizes, shapes, and weight. In general, a typical cathode-ray tube (CRT) monitor includes a display panel for displaying an image, a vacuum tube coupled to the rear of the display panel, and an electron gun coupled to the rear of the vacuum tube. This configuration is a huge factor in limiting the total volume and final weight of the CRT monitor. In addition to the problem mentioned above, the CRT monitor carries a huge problem in that a user is easily fatigued when looking at the CRT monitor over long hours due to its low image quality. It is this problem alone that many people switched to using a flat screen display monitor, e.g., Liquid Crystal Display (LCD) monitor, from the conventional CRT monitors. Such flat display monitors generally offer the advantages of a greatly reduced size and weight properties including the ability to produce a high image quality. Furthermore, flat screen display monitors may help to overcome space limitations through folding over (such as with a laptop computer) or rotating (such as with a desktop monitor) so as to facilitate adjustment of the position thereof relative to the user.

The rotating or folding-over functions of the flat display monitor are realized with a hinge assembly. A hinge assembly includes an L-shaped fixed seat, a pivotal axle, and multiple oiled washers. The fixed seat has a retaining hole defined thereof. The pivotal axle is pivotally connected with the fixed seat. The pivotal axle has a retaining shoulder formed at a middle portion thereof, a connecting end portion integrally formed at a first end of the retaining shoulder, and a fixing end portion integrally formed at a second end of the retaining shoulder. The connecting end portion of the pivotal axle is extended through a retaining hole of the fixed seat along with multiple oiled washers, and then fastened by a fastening piece. However, in use, it is needed to use great efforts to rotate the hinge assembly, since a greater force is exerted thereon. As a result, it is inconvenient for a user to operate the hinge assembly.

Therefore, a new hinge assembly is desired in order to overcome the above-described shortcomings.

### SUMMARY

In one embodiment thereof, a hinge assembly includes a support seat, a base seat and a pivot mechanism. The support seat defines a pivoting hole. The base seat defines an engaging hole. The pivot mechanism rotatably connects the support seat to the base seat. The pivot mechanism includes an irregular-holed tab washer defining an irregular hole and a pivotal shaft. The irregular-holed tab washer is non-rotatably mounted to the support seat. The pivotal shaft non-rotatably engages in the engaging hole of the base seat and rotatably engages in the pivoting hole of the support seat. The irregular-holed tab washer surrounds the pivotal shaft. The pivotal shaft engages with the irregular hole of the irregular-holed tab washer for limiting a rotation angle between the support seat and the base seat.

Other advantages and novel features will become more apparent from the following detailed description when taken in conjunction with the accompanying drawings.

### BRIEF DESCRIPTION OF THE DRAWINGS

Many aspects of the hinge assembly can be better understood with reference to the following drawings. The components in the drawings are not necessarily drawn to scale, the emphasis instead being placed upon clearly illustrating the principles of the hinge assembly. Moreover, in the drawings, like reference numerals designate corresponding parts throughout the several views.

FIG. 1 is an isometric view of an embodiment of a hinge assembly, as used in a flat display monitor;

FIG. 2 is an exploded, isometric view of the hinge assembly in FIG. 1;

FIG. 3 is an assembled, isometric view of the hinge assembly in FIG. 2 viewed from a first direction;

FIG. 4 is similar to FIG. 3, but viewed from a second direction; and

FIG. 5 is a cut-away view taken along line V-V of FIG. 4.

### DETAILED DESCRIPTION OF THE EMBODIMENTS

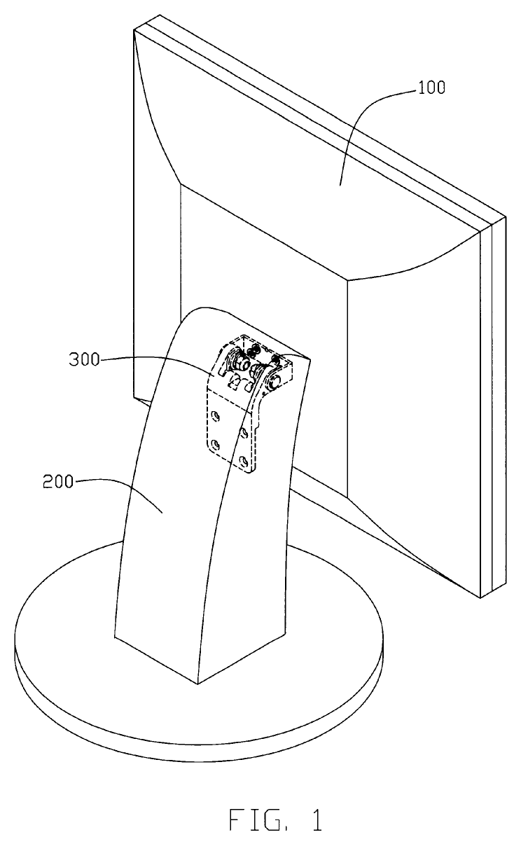

Referring to drawings in detail, FIG. 1 shows a flat display monitor employing a hinge assembly 300 in accordance with an embodiment of the present application. The flat display monitor is taken here as an exemplary application, for the purposes of describing details of the hinge assembly 300. It is to be understood, however, that the hinge assembly 300 could be advantageously used in other environments (e.g. cabinet doors). As such, although providing particularly advantages when used in flat display monitors, the hinge assembly 300 should not be considered limited in scope solely to an intended use environment of flat display monitors. A hinge assembly 300 is illustrated in the flat display monitor as shown in FIG. 1. The flat display monitor includes a display unit 100 and a support body 200. The hinge assembly 300 connects the display unit 100 to the support body 200 so that the display unit 100 can be pivoted relative to the support body 200.

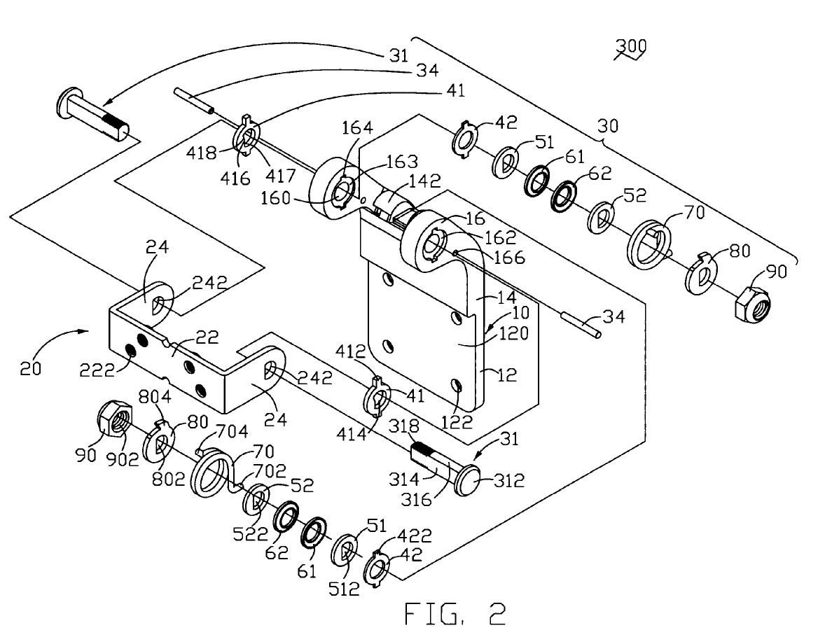

Referring to FIG. 2, the hinge assembly 300 includes a support seat 10, a base seat 20, and two pivot mechanisms 30 each including a pivotal shaft 31, a pin 34, an irregular-holed tab washer 41, a tab washer 42, two D-hole washers 51 and 52, a pair of spring/cupped washers 61 and 62, a resilient element 70, a limiting washer 80, and a screw nut 90.

The support seat 10 includes a mounting portion 12, a connecting portion 14, and two extending portions 16. The mounting portion 12 and the connecting portion 14 are substantially boards with the connecting portion 14 being thicker than the mounting portion 12. The mounting portion 12 has a surface 120 and defines a plurality of mounting holes 122. In this embodiment, there are four mounting holes 122. The support seat 10 is mounted to the support body 200 by means of the mounting holes 122. An end of the connecting portion 14 is connected to the mounting portion 12 and another opposite end forms two protrusions 142 and two extending portions 16. Each of the protrusions 142 is configured to be a triangular prism shaped like. The protrusions 142 are configured to be in between the two extending portions 16 that are slanted toward the surface 120. Each extending portions 16 forms a cylinder and defines a central pivoting hole 160 and a pinhole 166 adjacent to the pivoting hole 160. An end of each extending portion 16 defines a washer housing depression 162 and another opposite end of each extending portion 16 defines a washer housing depression 163. Each extending portion 16 further defines two opposite receiving slots 164 at a periphery of each of the washer housing depressions 162 and 163. The pin 34 is tightly inserted into the pinhole 166 and a substantial length of the pin 34 extends between the two extending portions 16.

The base seat 20 includes a fixing board 22 and two sideboards 24. The fixing board 22 defines a plurality of threaded assembling holes 222. In this embodiment, there are four assembling holes 222. The base seat 20 is mounted to the display unit 100 by means of the assembling holes 222. Two opposite edges of the fixing board 22 each forms a sideboard 24 perpendicularly extending outwards. Each of the sideboards 24 defines an engaging hole 242. The engaging holes 242 are deformed, i.e., are non-circular holes. In this embodiment, the engaging holes 242 are “D” shaped.

The pivotal shaft 31 is substantially cylindrical in shape. The pivotal shaft 31 includes a bolt cap 312 and a bolt shaft 316. The bolt cap 312 is substantially a disk-like shape. The bolt shaft 316 defines a thread 318 on a distal end portion thereof opposite to the bolt cap 312. The bolt shaft 316 is flattened along a line parallel to an axis of the bolt shaft 316 of the curved surface area forming a flat surface 314 resulting the thread 318 thereof non-continuous and the section of the bolt shaft 316 corresponds to the shape and size of the engaging hole 242 of the base seat 20. The bolt shaft 316 passes through one engaging hole 242 of the base seat 20 and one pivoting hole 160 of the support seat 10 correspondingly.

The irregular-holed tab washers 41 is approximately ring-shaped. Two opposite first tabs 412 are formed at a periphery of each irregular-holed tab washer 41. The irregular-holed tab washer 41 defines an irregular hole 414 in the center thereof. The first tabs 412 of the irregular-holed tab washer 41 are configured to engage in the receiving slot 162 of the extending portion 16 of the support seat 10. A limiting protrusion 416 extends inwards on an arc of the irregular hole 414. The limiting protrusion 416 has two symmetrical edges 417 and 418 and is substantially □-shaped (i.e., a rotated wide-angle V shape). An angle defined by the edges 417 and 418 establishes the rotational angle limits for the two pivot mechanisms 30 of hinge assembly 300 and, thus, for the display unit 100 relative to the support body 200. One such limiting protrusion 416 is readily manufactured. A precision of rotation range is easily controlled.

The tab washers 42 are approximately ring-shaped. Two opposite tabs 422 are formed at a periphery of each tab washer 42. The second tabs 422 of the tab washer 42 are configured to engage in the receiving slot 163 of the extending portion 16 of the support seat 10.

The D-hole washers 51 and 52 are approximately ring-shaped. The washers 51 and 52 define a first latching hole 512 and a second latching hole 522 respectively. The first and second latching holes 512 and 522 are both deformed, i.e., are non-circular holes. In this embodiment, the first and second latching holes 512 and 522 are “D” shaped. That is, the first and second latching holes 512 and 522 have a corresponding shape and size to the engaging hole 242 of the base seat 20.

The spring washers 61 and 62 are disked-shaped. The two spring washers are configured to provide an axial force. An amount of friction that helps the display unit 100 retaining any desired position relative to the support body 200 is generated between the elements of the pivot mechanisms.

The resilient element 70 is a helical torsion spring having a first latching end 702 and a second latching end 704. The first latching end 702 extends along a radial direction of the resilient element 70 and the second latching end 704 extends along an axial direction. When the hinge assembly 300 is assembled, the resilient element 70 exerts a predetermined torsion force. A diameter of the resilient element 80 is larger than that of the irregular-holed tab washer 41, the tab washer 42, the D-hole washers 51 and 52, and the spring washers 61 and 62.

The limiting washer 80 is approximately ring-shaped. The limiting washer 80 defines a third latching hole 802. The third latching hole 802 is deformed, i.e., are non-circular holes. In this embodiment, the third latching hole 802 is “D” shaped. That is, the third latching hole 802 has a corresponding shape and size of the engaging hole 242 of the base seat 20. The limiting washer 80 forms a limiting block 804 at its periphery. The limiting block 804 approximately extends along an involute of the limiting washer 80.

The screw nut 90 defines a thread 902 therein to be fastened with the thread 318 of the bolt shaft 316 of the pivotal shaft 31.

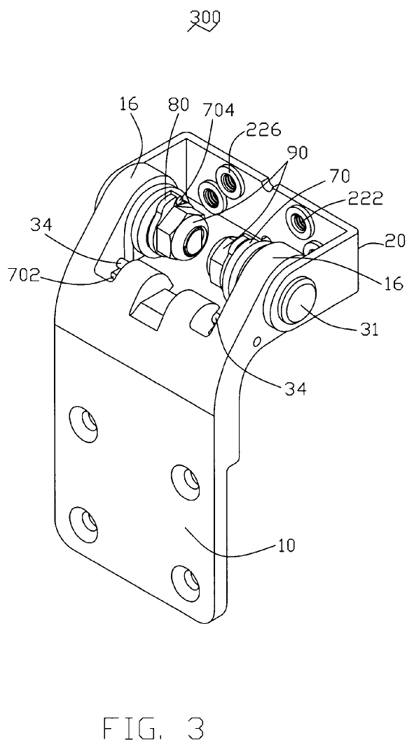

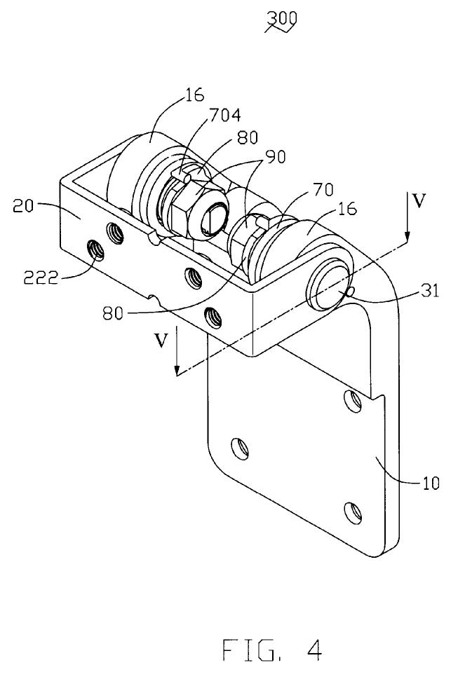

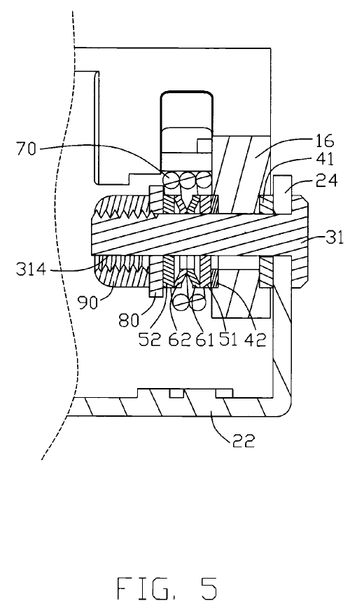

During assembly, referring now to FIGS. 3-5, the irregular-holed tab washers 41 are disposed in the washer housing depressions 162 and the tab washers 42 are disposed in the washer housing depressions 163 of support seat 10. The first and second tabs 412 and 422 of the irregular-holed tab washers 41 and tab washers 42 are fixed in the receiving slots 164 so as to make the irregular-holed tab washers 41 and tab washers 42 be non-rotatable relative to the extending portion 16 of the support seat 10. The pins 34 are securedly attached to the support seat 10. One resilient element 70 is placed around the bolt shaft 316 of one pivotal shaft 31 correspondingly. The resilient element 70 has a predetermined torque force. The bolt shaft 316 of the pivotal shaft 31 passes through the engaging hole 242 of one sideboard 24 of the base seat 20, the irregular hole 414 of one irregular-holed tab washer 41, the pivoting hole 160 of one extending portion 16 of the support seat 10, one tab washer 42, one D-hole washer 51, two spring washers 61 and 62, one D-hole washer 52, and one limiting washer 80, in that order. The spring washers 51 and 52 are disposed adjacent each other facing opposite directions. The first latching end 702 of the resilient element 70 pushes the pin 34, and the second latching end 704 of the resilient element 70 pushes the limiting block 804 of the limiting washer 80. The screw nut 90 is screwed via the thread 318 on the pivotal shaft 31. The screw nut 90 is adjoining the limiting washer 80. Thereby, a pivot mechanism 30 is formed. Another pivot mechanism 30 is formed in similar manners.

After assembling, the irregular-holed tab washers 41 and the tab washers 42 are non-rotatable relative to the support seat 10. The D-hole washers 51 and 52, the limiting washers 80, the pivotal shafts 31, and the screw nuts 90 are non-rotatable relative to the base seat 20. The irregular-holed tab washer 41, the tab washer 42, the D-hole washers 51 and 52, the spring washers 61 and 62, and the limiting washer 80, collaboratively maintain the desired spacing between the various portions of the pivot mechanism of the hinge assembly 300. Furthermore, the irregular-holed tab washer 41, the tab washer 42, the D-hole washers 51 and 52, the spring washers 61 and 62, and the limiting washer 80 collaboratively produce an amount of friction that allows movement of the display unit 100 relative to the support body 200 upon application of a moderate external force but that, otherwise, helps retain the desired positioning between the support body 200 and the display unit 100. Part of the needed friction can, be expected to be gained through the operation of the other elements of the hinge assembly 300, as well.

In use, a pushing force is exerted on the display unit 100, and, in turn, the display unit 100 causes the base seat 20 to likewise move. The D-hole washers 51 and 52, the limiting washers 80 and the pivotal shafts 31 also rotate with the base seat 20. Accordingly, the second latching ends 704 of the resilient elements 70 that push the limiting blocks 804 of the limiting washers 80 rotate, whereby increasing or decreasing the torsion force of the resilient elements 70. Suppose that the display unit 100 is in a middle position, the torsion force of the resilient elements 70 increases when the display unit 100 rotates toward a first direction and the torsion force decreases when the display unit 100 rotates toward an opposite second direction. The support seat 10 is fixed relative to the support body 200. When the display unit 100 rotates through a determined angle toward the first direction, the edge 417 pushes the flat surface 314 to prevent the base seat 20 rotating further. When the display unit 100 rotates through a determined angle toward the second direction, the edge 418 pushes the flat surface 314 so as to prevent the base seat 20 rotating further. Thereby, the display unit 100 together with the base seat 20 cannot rotate further accordingly. The irregular-holed tab washers 41 and the tab washers 42 disposed between the support seat 10 and the base seat 20 may decrease the abrasion between the support seat 10 and the base seat 20 so as to prolong the use life.

In alternative embodiments, the pivotal shaft 31 is fastened, e.g., by means of other holding members such as a rivet or by a ring. In this manner, a C-shaped ring and a receiving groove for example, replace the screw nut 90 and the thread 318 of the bolt shaft 316. Only single pivot mechanism 30 may be provided. Accordingly, the extending portion 16 of the support seat 10, the sideboard 24 of the base seat 20 and the pin 34 may also exist singularly. Other flat washers with non-circular hole may replace the D-hole washers 51 and 52. Other resilient members such as springs and other elastic washers may replace the spring washers 61, 62. The support seat 10 may be mounted to the display unit 100, and accordingly the base seat 20 may be mounted to the support body 200.

As described above, the preferred embodiments provides a hinge assembly 300 for devices such as a flat display screen, which is convenient for a user to operate and which is durable. It is, however, to be understood that the hinge assembly 300 could potentially be useful in other applications (e.g., a free-standing, adjustable mirror) in which it may be desirable to allow selective pivoting over a limited angular range.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a support seat defining a pivoting hole;
a base seat defining an engaging hole; and
a pivot mechanism for rotatably connecting the support seat to the base seat, the pivot mechanism comprising:
a resilient element residing between the support seat and the base seat for providing a torsion force;
an resilient member for providing an axial force;
an irregular-holed tab washer defining an irregular hole, the irregular-holed tab washer non-rotatably mounted to the support seat;
a pivotal shaft non-rotatably engaging in the engaging hole of the base seat and rotatably engaging in the pivoting hole of the support seat, the resilient member and the irregular-holed tab washer surrounding the pivotal shaft, the pivotal shaft comprising a bolt cap and a bolt shaft engaging with the irregular hole of the irregular-holed tab washer for limiting a rotation angle between the support seat and the base seat, the resilient element; and
a holding member disposed on the pivotal shaft in a manner so as to prevent the resilient member and the irregular-holed tab washer from being disengaged with the pivotal shaft.

2. The hinge assembly as claimed in claim 1, wherein the irregular-holed tab washer forms a V-shaped limiting protrusion extending inwards on an arc of the irregular hole, the protrusion has two symmetrical edges, the bolt shaft of the pivotal shaft has a flat surface for pivotally engaging with the edges of the limiting protrusion.

3. The hinge assembly as claimed in claim 2, wherein the pivot mechanism further comprises a tab washer and two flat washers, the tab washer and flat washers surrounds the pivotal shaft, the resilient member comprises two elastic washers disposed adjacent each other facing opposite directions, the irregular-holed tab washer is disposed between the support seat and the base seat, the tab washer is disposed adjoining to the support seat, the flat washers are disposed at two sides of the elastic washers.

4. The hinge assembly as claimed in claim 3, wherein the support seat comprises a mounting portion, a connecting portion and an extending portion, the mounting portion and the connecting portion are substantially boards, the extending portion is a cylinder defining the pivoting hole.

5. The hinge assembly as claimed in claim 4, wherein the extending portion defines two washer housing depressions at two opposite ends thereof for non-rotatably receiving the irregular-holed tab washer and the tab washer, and two opposite receiving slots at a periphery of each washer housing depression, the irregular-holed tab washer and the tab washer each forms two opposite tabs engaging in the receiving slots.

6. The hinge assembly as claimed in claim 4, wherein the resilient element is a helical torsion spring having a first latching end and a second latching end, the extending portion defines a pinhole adjacent to the pivoting hole, the pivot mechanism further comprises a pin fixedly engaging in the pinhole, most portion of the pin extends between the two extending portions, the first latching end of the resilient element resists the pin.

7. The hinge assembly as claimed in claim 6, wherein the pivot mechanism further comprises a limiting washer, the limiting washer is approximately ring-shaped, the limiting washer defines a latching hole for non-rotatably engaging with the pivotal shaft, and forms a limiting block at its periphery, the second latching end of the resilient element resists the limiting block.

8. The hinge assembly as claimed in claim 7, wherein the flat washers are approximately ring-shaped each defining a latching hole for engaging with the pivotal shaft, the latching holes of the flat washers and the limiting washer, and the engaging hole of the base seat are “D” shaped.

9. The hinge assembly as claimed in claim 4, wherein the base seat comprises a fixing board and a sideboard perpendicular to the fixing board, the engaging hole is defined in the sideboard.

10. The hinge assembly as claimed in claim 9, wherein one more extending portion of the support seat, one more sideboard of the base seat and one more pivot mechanism are provided.

11. The hinge assembly as claimed in claim 1, wherein the bolt shaft of the pivotal shaft defines a thread on a distal end portion thereof opposite to the bolt cap, the holding member is a screw nut to engage with the thread of the pivotal shaft.

12. A display monitor, comprising:
a support body;
a display unit; and
a hinge assembly configured for rotatably connecting the support body and the display unit, the hinge assembly comprising:
a support seat defining a pivoting hole, the support seat being fixedly connected to one of the support body and the display unit;
a base seat defining an engaging hole, the base seat being fixedly connected to another one of the support body and the display unit; and
a pivot mechanism for rotatably connecting the support seat to the base seat, the pivot mechanism comprising:
a resilient element residing between the support seat and the base seat for providing a torsion force;
an resilient member for providing an axial force;
an irregular-holed tab washer defining an irregular hole, the irregular-holed tab washer non-rotatably mounted to the support seat;
a pivotal shaft non-rotatably engaging in the engaging hole of the base seat and rotatably engaging in the pivoting hole of the support seat, the resilient member and the irregular-holed tab washer surrounding the pivotal shaft, the pivotal shaft comprising a bolt cap and a bolt shaft engaging with the irregular hole of the irregular-holed tab washer for limiting a rotation angle between the support seat and the base seat, the resilient element; and
a holding member disposed on the pivotal shaft to prevent the resilient member and the irregular-holed tab washer from being disengaged with the pivotal shaft.

13. The hinge assembly as claimed in claim 12, wherein the irregular-holed tab washer has a V-shaped limiting protrusion extending inwards on an arc of the irregular hole, the protrusion has two symmetrical edges, the bolt shaft of the pivotal shaft has a flat surface for pivotally engaging with the edges of the limiting protrusion.

14. The hinge assembly as claimed in claim 13, wherein the pivot mechanism further comprises a tab washer and two flat washers, the tab washer and flat washers surrounds the pivotal shaft, the resilient member comprises two elastic washers disposed adjacent each other facing opposite directions, the irregular-holed tab washer is disposed between the support seat and the base seat, the tab washer is disposed adjoining to the support seat, the flat washers are disposes at two sides of the elastic washers, the irregular-holed tab washer and the tab washer are non-rotatably relative to the support seat.

15. The hinge assembly as claimed in claim 14, wherein the support seat comprises a mounting portion, a connecting portion and an extending portion, the mounting portion and the connecting portion are substantially boards, the mounting portion defines a plurality of mounting holes for engaging with the support body or the display unit, and the extending portion defines the pivoting hole.

16. The hinge assembly as claimed in claim 15, wherein the resilient element is a helical torsion spring having a first latching end and a second latching end, the extending portion defines a pinhole adjacent to the pivoting hole, the pivot mechanism further comprises a pin fixedly engaging in the pinhole and a limiting washer defines a latching hole for non-rotatably engaging with the pivotal shaft, the limiting washer forms a limiting block at its periphery, the first latching end of the resilient element resists the pin, the second latching end of the resilient element resists the limiting block.

17. The hinge assembly as claimed in claim 12, wherein the base seat comprises a fixing board and a sideboard perpendicular to the fixing board, the engaging hole is defined in the sideboard, the fixing board defines a plurality of assembling holes for engaging with the support body or the display unit.

18. A hinge assembly, comprising:
a support seat defining a pivoting hole;
a base seat defining an engaging hole; and
a pivot mechanism rotatably connecting the support seat to the base seat, the pivot mechanism comprising:
an irregular-holed tab washer defining an irregular hole, the irregular-holed tab washer non-rotatably mounted to the support seat; and
a pivotal shaft non-rotatably engaging in the engaging hole of the base seat and rotatably engaging in the pivoting hole of the support seat, the irregular-holed tab washer surrounding the pivotal shaft, the pivotal shaft engaging with the irregular hole of the irregular-holed tab washer for limiting a rotation angle between the support seat and the base seat.

19. The hinge assembly as claimed in claim 18, wherein the pivot mechanism further comprises an resilient member for providing an axial force, a resilient element providing torsion force, a tab washer, two flat washers, a limiting washer, a holding member surrounding the pivotal shaft and a pin, the irregular-holed tab washer is disposed between the support seat and the base seat, the tab washer is disposed adjoining to the support seat, the flat washers are disposes at two sides of the elastic washers.

20. The hinge assembly as claimed in claim 18, wherein the irregular-holed tab washer has a V-shaped limiting protrusion extending inwards on an arc of the irregular hole, the protrusion has two symmetrical edges, the pivotal shaft has a flat surface for pivotally engaging with the edges of the limiting protrusion.
